(19) United States
(12) Patent Application Publication
(10) Pub. No.: US 2015/0362603 A1
(43) Pub. Date: Dec. 17, 2015

(54) DETECTOR MODULE FOR AN X-RAY DETECTOR

(71) Applicant: Siemens Aktiengesellschaft, München (DE)

(72) Inventors: Robert John ELLWOOD, Erlangen (DE); Thorsten ERGLER, Erlangen (DE); Miguel LABAYEN DE INZA, Forchheim (DE); Claus POHAN, Baiersdorf (DE); Stefan WÖLFEL, Dormitz (DE)

(21) Appl. No.: 14/727,938

(22) Filed: Jun. 2, 2015

(30) Foreign Application Priority Data
Jun. 17, 2014 (DE) 102014211602.3

(51) Int. Cl. G01T 1/24

(52) U.S. Cl. CPC G01T 1/244

(57) ABSTRACT

A detector module for an X-ray detector is disclosed, which includes, in a stacked structure, a sensor layer with a sensor surface to which a high voltage can be applied for the detection of X-rays. A coherent protective film is arranged on at least two side surfaces of the stacked structure. An X-ray detector is also disclosed, including a number of corresponding detector modules.

### PRIORITY STATEMENT

The present application hereby claims priority under 35 U.S.C. §119 to German patent application number DE 102014211602.3 filed Jun. 17, 2014, the entire contents of which are hereby incorporated herein by reference.

### FIELD

At least one embodiment of the invention generally relates to a detector module for an X-ray detector. At least one embodiment of the invention further generally relates to an X-ray detector comprising a number of detector modules.

### BACKGROUND

An X-ray detector, in particular a quantum-counting X-ray detector, is used in imaging applications. An X-ray detector of this kind is used, for example, for computed tomography images in medical imaging in order to generate a three-dimensional image of a region of a patient under examination.

Here, an X-ray detector with a sensor layer embodied as a directly converting semiconductor layer enables the quantitative and energy-selective detection of individual X-ray quanta. On the incidence of X-rays, electron-hole pairs, that is pairs of negative and positive charge carriers are generated in the sensor layer. A voltage applied to the sensor layer or to the surface of the sensor layer causes the charge carriers to separate and move toward the respective oppositely charged electrodes or surfaces of the sensor layer. The current resulting from this or a corresponding charge transfer can be evaluated by downstream sensor electronics. Semiconductor materials in the form of CdTe, CdZnTe, CdTeSe, CdZnTeSe or CdMnTe with high X-ray absorption are, for example, suitable for the detection of X-ray quanta.

In particular a computed tomography scanner requires large-area X-ray detectors. However, the production of continuous sensor layers with an edge length of several tens of centimeters is technically very complicated and associated with high costs.

In order nevertheless to be able to produce large-area X-ray detectors as inexpensively as possible, frequently several comparatively small X-ray modules with the above-described structure are arranged next to one another. These detector modules typically have a sensor surface of between 1 cm2 and 4 cm2 and are arranged with the lowest possible distance between the respective module edges in order to achieve an as continuous as possible detector coverage (high “fill” factor) and hence high image quality.

Detector modules of this kind are highly sensitive and mechanically susceptible. Accordingly, this complicates their handling. In particular during the production process, during assembly or even in the case of replacement due to damage, there is a risk that the respective detector module will be easily damaged. Fault-free function of the detector module, and hence of the X-ray detector as such, can only be ensured with complicated monitoring.

### SUMMARY

At least one embodiment of the invention provides a detector module which is more robust and in this sense is easier to handle. At least one embodiment of the invention provides an X-ray detector with a number of corresponding detector modules.

At least one embodiment of the invention includes a detector module for an X-ray detector comprising in a stacked structure a sensor layer with a sensor surface to which a high voltage can be applied for the detection of X-rays, wherein a coherent protective film is arranged on at least two side surfaces of the stacked structure.

At least one embodiment of the invention includes an X-ray detector for recording an image of an object radiographed by X-rays with a number of detector modules arranged adjacent to one another according to one of the above-described embodiments.

### BRIEF DESCRIPTION OF THE DRAWINGS

The following describes example embodiments of the invention in more detail with reference to a drawing. Here, corresponding components in the figures are designated with the same reference characters. The figures show:

FIG. 1 a detector module for an X-ray detector and a protective film to be applied on three side surfaces and on the sensor surface of a detector module in a side view,

FIG. 2 the detector module according to FIG. 1 with the applied protective film in a side view,

FIG. 3 the protective film according to FIGS. 1 and 2 in a top view,

FIG. 4 a further detector module with a protective film applied on three side surfaces and the sensor surface in a side view,

FIG. 5 a further detector module with a protective film applied on the side surfaces and on the sensor surface in a side view,

FIG. 6 a further detector module with a protective film applied on three side surfaces in a side view,

FIG. 7 a further detector module with a shrink-on sleeve surrounding four side surfaces before and after temperature treatment in a top view,

FIG. 8 a further detector module with two shrink-on rings each surrounding two side surfaces before and after temperature treatment in a top view and

FIG. 9 a further detector module with a shrink-on sleeve surrounding four side surfaces.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the invention includes a detector module for an X-ray detector comprising in a stacked structure a sensor layer with a sensor surface to which a high voltage can be applied for the detection of X-rays, wherein a coherent protective film is arranged on at least two side surfaces of the stacked structure.

In a first step, at least one embodiment of the invention is based on the consideration that, during the handling of detector elements to be installed, function-impairing damage can occur relatively easily, for example, this is the case in the event of contamination or mechanical damage to the stacked structure or the sensor layer as such. Accordingly, safety and cleaning measures are necessary both in service and during the production process in order to avoid damage of this kind to the greatest degree as possible.

In a second step, at least one embodiment of the invention recognizes that a film is suitable as mechanical protection for a detector module. This film can simultaneously also be used for electrical insulation of adjacent detector modules. In particular, the preferably electrically insulating film can remain permanently on the detector module and optionally perform other tasks in addition to its mechanical and insulating protective action. To protect against mechanical damage, the film is arranged as a coherent protective film on at least two side surfaces of the stacked structure of the detector module so that in particular effective edge protection is simultaneously provided. On the side surfaces of the stacked structure, an optically opaque protective film also prevents the incidence of optical light in the detector material, which results in unwanted inhomogeneous leakage current flows in the detector module.

The handling of a detector module provided with a protective film of this kind is significantly simplified during assembly and in particular during servicing. Thus, for example, in the event of a detector being unintentionally struck on the edge or a detector module being dropped, the protective film prevents a fragment of a sensor from breaking off so that additional safety and cleaning measures can be reduced to extreme cases that do not as a rule occur during servicing and production.

The coherent protective film is arranged on at least two side surfaces of the detector module. In other words, several side surfaces of a detector module are covered by a common protective film, wherein the coverage can be partial or over the entire area. For this, depending upon the number of side surfaces of the detector module to be covered, the geometry of the protective film preferably has corresponding bend regions at the transition points between the side surfaces. The bend regions can be formed by selective material recesses or material reductions on the protective film.

In addition to the sensor layer and the sensor surface, a detector module advantageously comprises further individual components in a stacked structure. The sensor layer can, for example, be in direct electrical contact with a readout unit, such as, for example, an ASIC. However, the sensor layer can also be applied on a separate carrier material. In particular a plurality of individual sensors (divided sensor layers) and readout units can be arranged inside a detector module. Accordingly, the protective film can additionally or alternatively also extend over the readout unit and/or over the carrier material or be arranged and cover this partially or over the entire area at the side. Thus, in addition to the sensor layer as such, the further components used in a detector module can be reliably protected against mechanical damage or against electrical spark-overs etc. Here, it is preferable only to fix the protective film on a carrier ceramic.

In a particularly advantageous embodiment of the invention, the protective film covers the entire area of the side surfaces of the detector module. This can achieve complete protection of the side surfaces and the corresponding corners covered by the coherent protective film. In the case of an optically opaque film this can also prevent the disruptive incidence of optical light.

In an expedient embodiment, a conductive layer is applied on the sensor surface. The primary aim of the conductive layer is to connect the normally already existing, similarly conductive, metallization of the sensor surface to an external voltage source over a large area. Hence, the conductive layer ensures that voltage applied from outside to the complete sensor surface is applied uniformly. In addition, the conductive layer also protects the highly sensitive sensor surface or the sensor layer from mechanical damage and possible tactile contact. In the event of a break (for example during servicing), fragments of material remain fixed at their original site and are not distributed in the close environment of the detector. The conductive layer can, for example, be applied as a conductive coating or as a conductive film on the sensor surface.

It is also advantageous for a protective film to be arranged on the sensor surface. This protective film is preferably permeable to X-ray quanta in order to facilitate the quantitative and energy-selective detection thereof. Here, the protective film can either be arranged directly on the sensor surface or, in the case of a conductive layer on the sensor surface, on said conductive layer. The protective film is used to cover the sensor surface which in this way can be effectively protected against contamination and mechanical damage.

In particular, an electrical insulating protective film applied on the sensor layer can prevent a short circuit between the upper and lower sides of the sensor layer, which, in the event of tactile contact (contamination by “greasy fingers”, moisture) with the conductive layer during assembly or during servicing, can be caused by the application of a high voltage. In the case of a sensor surface covered by an in particular electrical insulating protective film, the sensor layer is no longer directly accessible so that a service engineer is no longer able to come into contact with this during normal handling.

In another particularly advantageous embodiment, the protective film arranged on the sensor surface is embodied as a conductive film as such. Hence, the protective film simultaneously serves to protect the sensor surface.

In a further preferred embodiment of the invention, a coherent protective film is arranged on the side surfaces and on the sensor surface. Hence, a coherent protective film is used for simultaneous arrangement on the side surfaces and on the sensor surface or the conductive layer. This, for example with a rectangular detector module, can cover all four side surfaces and the sensor surface jointly and in particular over the entire area so that comprehensive protection of the detector module can be ensured. Hence, a coherent protective film of this kind covering several and in particular every side surface and the sensor surface or the conductive layer of a detector module serves equally as mechanical protection for the side surfaces, for the sensor edges and for the sensor surface of a detector module.

A protective film, which is arranged coherently both on the side surfaces and on the upper side of the detector module, that is on the sensor surface or the conductive layer, is preferably embodied with subareas that differ from one another. The subareas arranged on the side surfaces or covering these expediently consist of a non-electrically conductive material. The subarea of the protective film arranged on the sensor surface preferably has electrically conductive properties.

In the case of a one-piece geometry of the protective film used, the embodiment of said subareas can be achieved, for example, by a protective film produced in multiple layers with which the subarea arranged on the sensor surface is provided with a corresponding conductive layer. If there is already a conductive layer on the sensor surface, there is no need for a separate layer.

Since the voltage applied to a detector module during the operation of an X-ray detector is in an order of magnitude of about 2 kV, in the event of an error, for example due to a short circuit or a defective power supply unit, there may be a voltage drop at a detector module. Due to the spatial proximity of the adjacent detector modules, a voltage drop of this kind can result in spark-overs through the air between adjacent detector modules which can result in the destruction of both the sensor layer of the detector modules affected and the associated readout unit and/or the sensor electronics. However, increasing the distance between two detector modules is out of the question due to the resulting deterioration in image quality.

A protective film with the above-described properties can ensure the required electrical protection for a detector module even without increasing the distance. If the operating voltage of an adjacent detector module fails or drops below a specified voltage value, due to the increased air and creepage distances between two detector modules caused by the protective film, spark-over between these modules is prevented. Hence, in addition to the mechanical protection, as already mentioned, the protective film also takes on the function of electrical protection for adjacent detector modules of an X-ray detector.

It can be expedient to apply a layer of paint on the side surfaces of the detector module as protection for a detector module against incident optical light radiation.

It is particularly preferable for the optical protection to be implemented in that the protective film arranged on the side surfaces of the detector module is provided with optical protection. The optical protection shields the respective detector modules against incident optical light—in particular against IR radiation so that the aforementioned inhomogeneous leakage currents in the proximity of the side surfaces are reduced. In addition, an unwanted voltage drop on the side surfaces is prevented. Both are necessary for good image quality.

In a preferred embodiment, the optical protection is applied as a coating on the protective film. Here, the optical protection is expediently applied to the subareas of the protective film arranged on the side surfaces of the detector module. The coating can, for example, be applied in the form of a dark paint or a corresponding film on the protective film. Alternatively, the coating can also be performed by printing the corresponding subareas of the protective film.

In the status arranged on the detector module, the optical protection can either be applied internally, that is between the side surfaces of the detector module and the protective film applied, or externally on the film.

Preferably, the protective film is glued onto the side surfaces and/or onto the sensor surface. Gluing can ensure both simple assembly and reliable fixing of the protective film on the detector module which is uniform at every point. Due to the ease of handling and application, the use of a self-adhesive protective film is also suitable. Alternatively, it is also possible to apply a film with separately applied adhesive to a detector module.

Here, it is particularly advantageous, in particular for applying the film on the sensor surface, for the adhesive to have locally conductive properties. In the subarea of the protective film on the sensor surface to be glued, the adhesive can, for example, be mixed with metal particles that render the adhesive conductive.

Obviously, at least one embodiment of the invention also includes the mechanical application of the protective film on a detector module. For this, it is possible, for example, to use separate fixing devices.

In a particularly advantageous embodiment, the optical protection is applied as an adhesive layer on the protective film. In other words, the adhesive to fix the protective film on the side surfaces of the detector module, for example a liquid adhesive, takes on the function of optical protection. Then, there is no need for the application of a separate optical protection layer. For this, the adhesive used as optical protection is preferably non-optically transparent.

Expediently, the sensor layer in the stacked structure is applied on a readout unit. It is further expedient for the readout unit in the stacked structure to be applied on a carrier ceramic, which is suitable as an intermediate substrate for the transmission of signals from the readout unit to the sensor electronics and which represents an alternative to conventional printed-circuit boards.

Preferably, a plastic film is used as the protective film. For example, a Kapton film can be used. Plastics generally have a good insulating effect and are in particular inexpensive to procure and simple to handle. A Kapton film (a product of the company DuPont) is a film made of a polyimide and, due to its high heat resistance, high radiation resistance and particularly good insulating properties, is particularly suitable for use in an X-ray detector.

In a further advantageous embodiment, a shrink-on film is used as the protective film. In the case of a coherent shrink-on film arranged on four side surfaces of a rectangular detector module, it is possible, for example, to use a shrink-on sleeve. This is pulled over the detector module and heated. The heating and subsequent cooling causes the film to shrink under curing firmly around the detector module and to enclose said detector module. Alternatively, it is also possible to use shrink-on rings which are arranged such that in each case they coherently cover at least two side surfaces—partially or over the entire area—and lie thereupon when the temperature increases. Then, the ends of the shrink-on rings that meet at the edges of the detector module can be welded together.

Both a shrink-on sleeve and a shrink-on ring can preferably be selected such that, after temperature treatment in the stack direction, a projection over the sensor surface, that is the conductive layer, remains. In other words, the protective film extends beyond the sensor surface in the stack direction. A projection of this kind seals the transition from the respective side surfaces of the side surface to the sensor surface so that the detector module is also protected against damage in this transitional region.

Expediently, the sensor layer comprises cadmium telluride (CdTe), cadmium zinc telluride (CdZnTe), cadmium zinc tellurium selenide (CdZnTeSe), cadmium tellurium selenide (CdTeSe), cadmium manganese telluride (CdMnTe), indium phosphide (InP), thallium bromide (TlBr2) or mercury iodide (HgI2). Semiconductor materials of this kind enable the direct conversion of the incident radiation into an electric signal and are commercially available with good quality with respect to charge transport properties and homogeneity.

Overall, the arrangement of a coherent protective film on several side surfaces of a detector module enables this to be effectively protected against mechanical stresses thus rendering the handling of the detector module much simpler than is the case with conventional detector modules. In addition, in the integrated state of the detector module, the protective film represents spark-over protection between two adjacent detector modules. Optical protection additionally applied to the protective film enables shielding of incident optical light. Thus, depending on the embodiment, in an ideal case, the protective film simultaneously fulfils a mechanical, an electrical and an optical protection function for a corresponding detector module.

At least one embodiment of the invention includes an X-ray detector for recording an image of an object radiographed by X-rays with a number of detector modules arranged adjacent to one another according to one of the above-described embodiments.

During the operation of an X-ray detector, in each case, a high voltage is applied to the sensor surface of the detectors modules. As described above, the application of the high voltage, which is usually in range between 1000 V and 2000 V, enables the separation of the charge carriers generated by the X-rays in the sensor layer and hence the detection of the incident X-ray quanta.

The number of detector modules used in an X-ray detector depends upon their size and the total area required. Depending upon the arrangement and embodiment, the protective film, which is expediently arranged on each of the detector modules used, can be used either solely as mechanical protection or additionally or alternatively as electrical and optical protection.

Preferably, the carrier ceramic of the or each detector module in the stacked structure is connected via a carrier to sensor electronics. Thus, the data determined with X-ray imaging, that is the electrical signals from the direct conversion of the X-rays arriving on a sensor surface, can be directly evaluated and further used. For this, the sensor electronics can, for example, be read out with a corresponding evaluation routine.

Further embodiments of the X-ray detector may be derived from the subclaims directly at the detector module. Here, the advantages described for the detector can be transferred analogously to the X-ray detector.

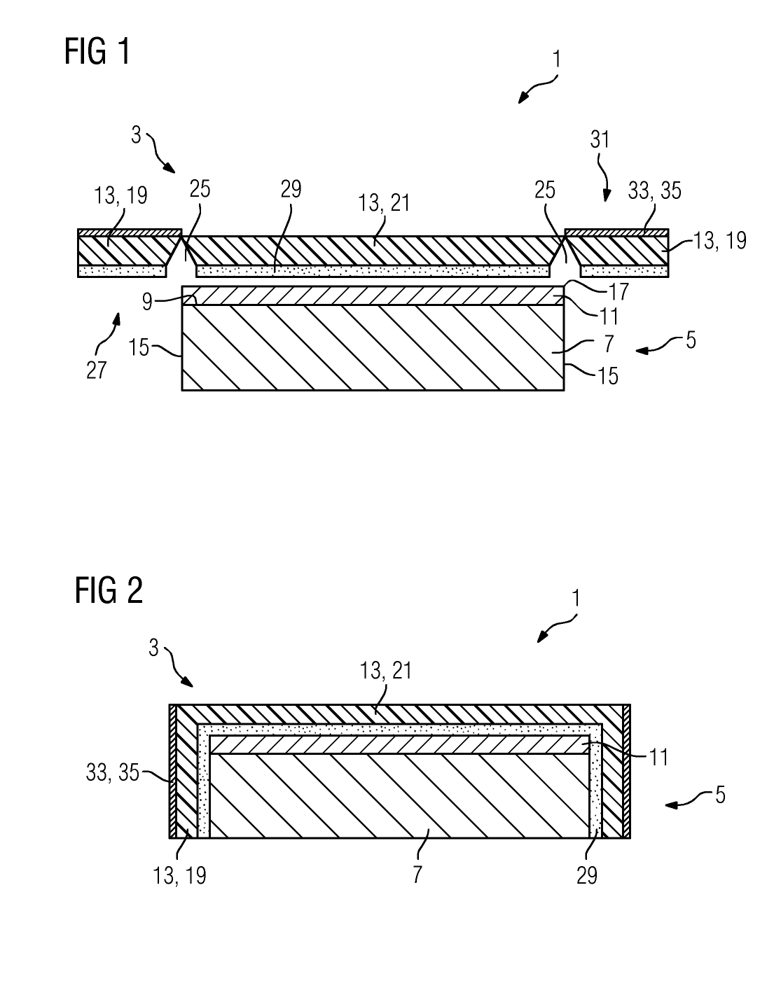

FIG. 1 is a side view of a detector module 1, which can be used in an X-ray detector 3. The detector module 1 comprises in a stacked structure 5 a sensor layer 7 with a sensor surface 9. A conductive layer 11 is applied on the sensor surface 9. The sensor layer 7 is used for the detection of X-rays. For this, in integrated state inside the X-ray detector 1, a high voltage is applied to the sensor surface 9 via an electrode (not shown).

FIG. 1 also shows a protective film 13. The protective film 13 is a plastic film, which can be arranged coherently both on the three side surfaces 15 and on the conductive layer 11. Further components of the detector module 1, such as a readout unit and a carrier ceramic, are not shown in this case.

The protective film 13 is used for both mechanical protection of the side surfaces 15 of the detector module 1 and protection of the edges 17 between two side surfaces 15 that meet. A protective film 13 of this kind in particular greatly simplifies the handling of a detector module 1 in assembly and during servicing, since for example, it is possible to prevent the splintering off of fragments of individual components of the detector module 1.

The protective film 13 has subareas 19, 21. The subareas 19 are arranged on the side surfaces 15 of the detector module 1 such that they cover them completely. The subarea 21 is used to cover the upper side 23 of the detector module 1, that is to cover the conductive layer 11.

Bend regions 25 are formed between the respective subareas 19, 21 for example by material abrasion at which the protective film 13 is bent when it is arranged on the detector module 1 and in this way placed around this. The bend regions 25 in arranged state are then arranged on the edges 17 of the detector module 1. For fixing on the detector module 1, the entire area of the side 27 of the protective film 13 facing the detector module 1 is provided with an adhesive layer 29 so that the protective film 13 can be glued on the sensor layer 7 and the conductive layer 11 of the detector module 1.

Moreover, the sides 31 of the subareas 19 of the protective film 13 facing away from detector module 1 are provided with optical protection 33 covering the entire area of the side surfaces 15 of the detector module 1 following the arrangement of the protective film 13. As optical protection 33, a coating 35 of opaque paint is applied on the protective film 13 to protect the side surfaces 15 from incident optical light radiation.

Additionally, the protective film 13 ensures electrical protection of the detector module 1 in the integrated state of the X-ray detector 3 since this enables the prevention of spark-overs between adjacent detector modules 1.

FIG. 2 shows the protective film 13 in the state arranged on the detector module 1. All subareas 19, 21 and also the optical protection 33 cover the entire area of the side surfaces 15 or the upper side 23. Following fixing by means of the adhesive layer 29, the entire detector module 1 is effectively protected against mechanical damage and against optical and electrical interference.

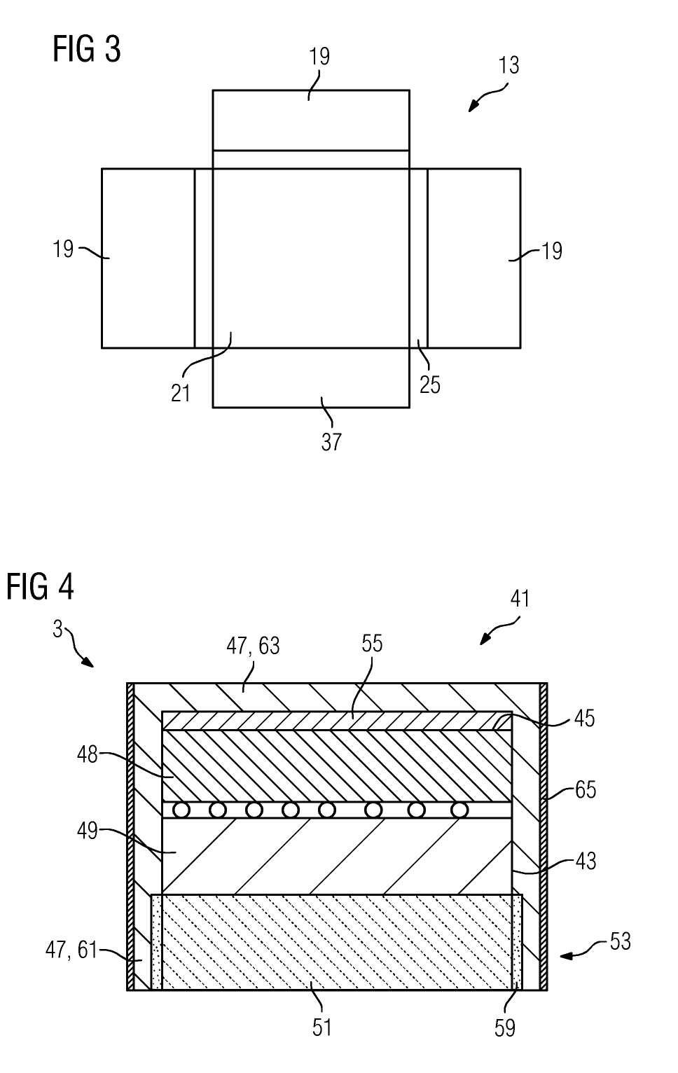

FIG. 3 shows the protective film 13 arranged on the detector module 1 according to FIGS. 1 and 2 in a top view. This depiction identifies the one-part geometry of the protective film 13. It visualizes both the three subareas 19, which can be arranged on the side surfaces 15 of the detector module 1 and the subarea 21, which is arranged on the conductive layer 11. A further subarea 37 shown is the one used for the electrical connection of the conductive layer 11. The bend regions 25, which, in arranged state, cover the edges 17 of the detector module 1, can also be identified.

FIG. 4 shows a further detector module 41 with a protective film 47 arranged on three side surfaces 43 and on the sensor surface 45 in a side view. In addition to the sensor layer 48, this case also shows the readout unit 49 and the carrier ceramic 51 as components of the detector module 41 in the stacked structure 53 are also shown.

In this case, the conductive layer 55 is applied as a coating on the protective film 47 and, on the arrangement of the protective film 47, comes to lie on the sensor surface 45. To fix the protective film 47 on the detector module 41, the side 57 of the protective film 47 facing the detector module 41 is provided locally with an adhesive layer 59.

Unlike the case in FIGS. 1 to 3, in this case adhesion is to the carrier ceramic 51. Thus, the protective film 47 offers the best possible protection for the entire detector module 41 to prevent sensor fragments from falling out. In principle, it is obviously also possible additionally or alternatively to glue the protective film 47 on the readout unit 49 and/or on the sensor layer 48 and the sensor surface 45.

The protective film 47 in turn has different subareas 61, 63, wherein an optical protection 65 in the form of a non-conductive coating 65 is applied to the entire area of the subareas 61 covering the side surfaces 43 of the detector module 41.

With respect to the further description of the components, at this point reference is made to the more detailed descriptions of FIGS. 1 to 3.

FIG. 5 shows a section of a further detector module 71 in a side view, which is also suitable for use in the X-ray detector 3. The detector module 71 comprises in a stacked structure 75 a sensor layer 77 with a sensor surface 79, and a readout unit 81 and a carrier ceramic 83.

Also arranged on the detector module 71 is a protective film 85 with different subareas 87, 89. The subareas 87 of the protective film 85 are glued on the side surfaces 91 of the detector module 71. Here, the adhesion is provided by an adhesive layer 93 only on the carrier ceramic 83.

In this case, the optical protection 95 of the side surfaces 91 used is applied on the side 97 facing the detector module 71 on the protective film 85. Hence, the optical protection 95 is located between the adhesive layer 93 and the protective film 85.

The subarea 89 of the protective film 85 arranged on the sensor surface 79 is provided with a conductive layer 99, which on the arrangement of the protective film 85 comes to lie on the detector module 71 on the sensor surface 79.

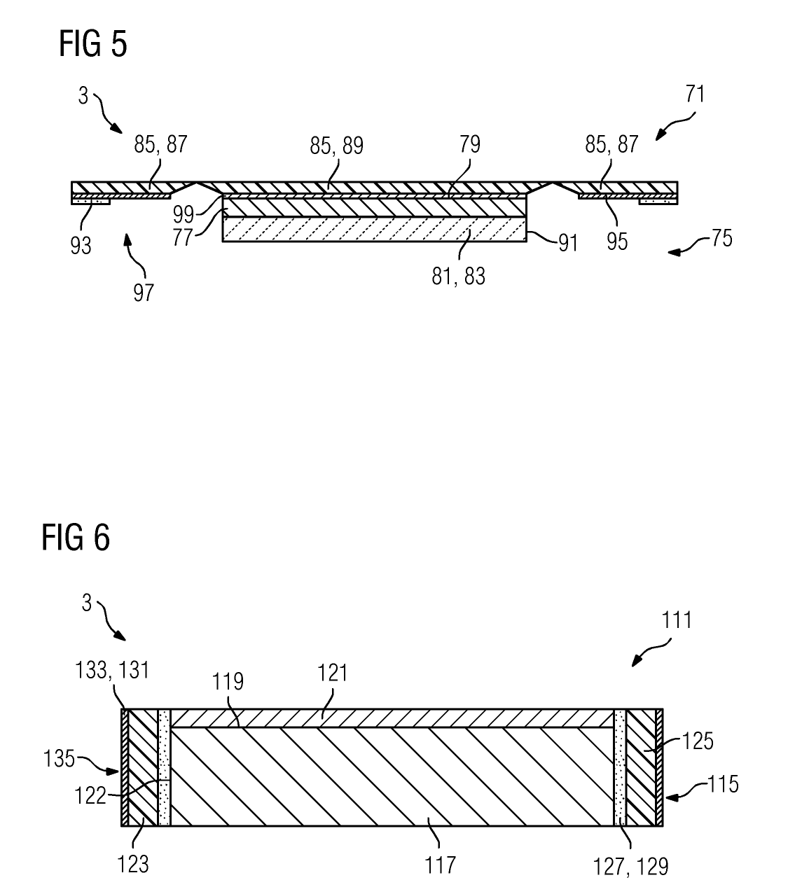

FIG. 6 shows a section of a further detector module 111 in a side view, which also comprises in a stacked structure 115 a sensor layer 117 with a sensor surface 119. A conductive layer 121, which in this case is used as the sole protection of the sensor surface 119, is applied on the sensor surface 119. Although an additional protective film on the sensor surface 119 is in principle possible, this is not provided here.

In this case, two side surfaces 122 of the detector module 111 are each provided with a coherent protective film 123, 125. The protective films 123, 125 cover the entire area of the side surfaces 122.

The protective films 123, 125 are fixed by means of an adhesive layer 129 applied on the inner side 127 of the protective films 123, 125. The optical protection 131 is achieved by a paint 133 applied on the outside side 135 of the protective films 123, 125 in the state arranged on the detector module 111.

FIG. 7 is a top view of a further detector module 141 for an X-ray detector 4 with a shrink-on sleeve 147 surrounding the four side surfaces 145 of the detector module 141 before and after temperature treatment.

For the arrangement of the shrink-on sleeve 147 on the side surfaces 145, it is pulled over the detector module 141 and heated. The heating and the subsequent cooling causes the shrink-on sleeve 147 to shrink and form a protective film 149 lying firmly on all four side walls 145 around the detector module 141 and to enclose said module. In this way, all four side surfaces 145 of the detector module 141 are reliably protected against mechanical damage.

The application of optical protection for the protection of the detector module 141 or the side surfaces 145 against incident optical light on the protective film 149 takes place following the shrinking-on of the shrink-on sleeve 147 and is not shown in the present case. The electrically conductive layer is also only applied following the shrinking-on of the shrink-on sleeve 147.

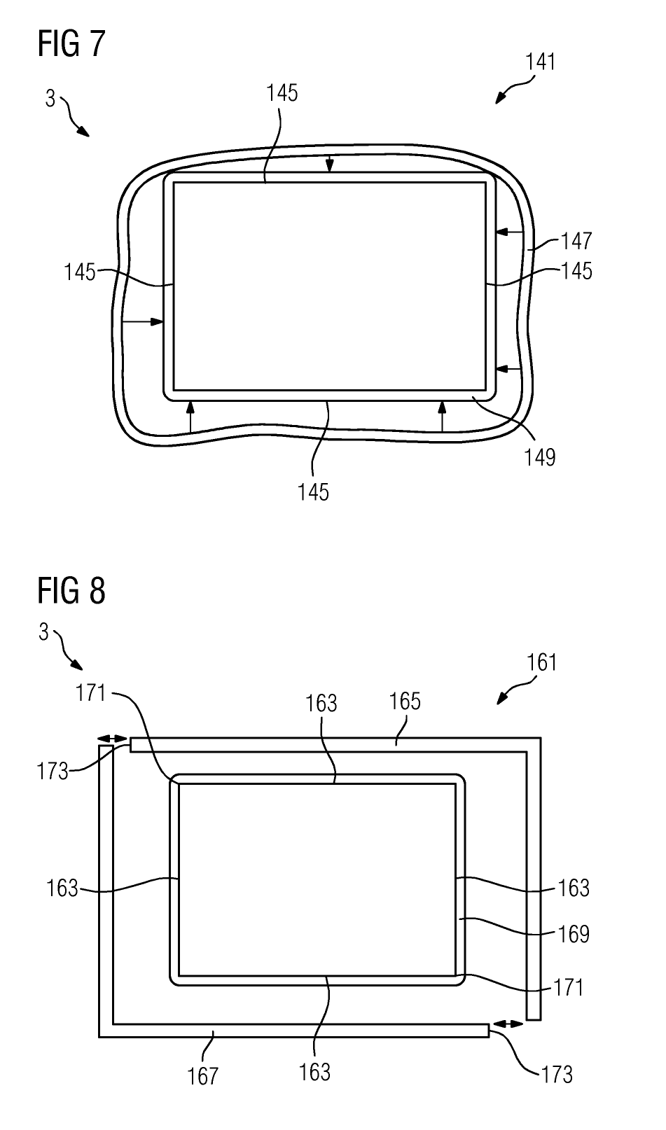

FIG. 8 shows a further detector module 161 as part of an X-ray detector 3 in a top view. In the present case, the four side surfaces 163 of the detector module 161 are surrounded by two shrink-on rings 165, 167 which are each shown before temperature treatment and after temperature treatment.

The shrink-on rings 165, 167 are arranged such that they in each case cover the entire area of the two side surfaces 163 coherently and, on an increase in temperature, lie thereupon with the formation of a protective film 169. The ends 173 of the shrink-on rings 165, 167 that meet at the corners 171 of the detector module 161 are then welded to each other.

As also shown in FIG. 7, both the application of optical protection to the protective film 169 and the application of an electrically conductive layer only take place following the shrinking process.

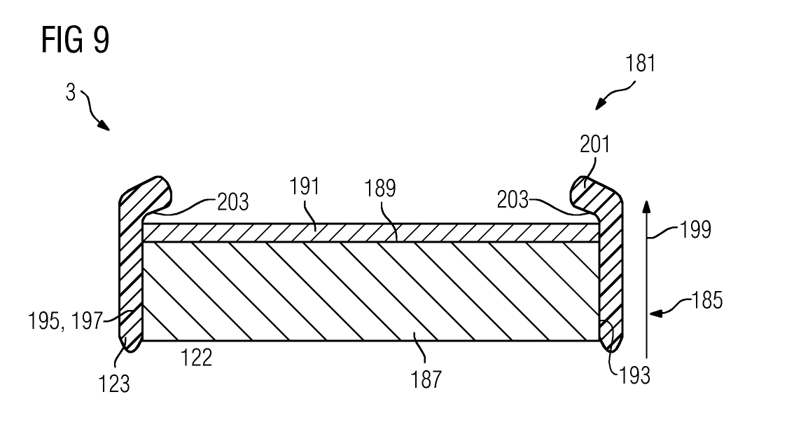

FIG. 9 shows a section of a further detector module 181 as part of an X-ray detector 3 in a side view. The detector module 181 comprises in a stacked structure 185 a sensor layer 187 with a sensor surface 189. A conductive layer 191 is provided on the sensor surface 189.

As in FIG. 7, the four side surfaces 193 of the detector module 181 are covered by a shrink-on sleeve 197 forming a protective film 195. In the present case, the shrink-on sleeve 197 is formed such that a projection 201 remains over the conductive layer 191 in the stack direction 199. Hence, the protective film 195 extends in the stack direction 199 beyond the conductive layer 191. A projection 201 of this kind, seals the transition from the respective side surfaces 193 to the conductive layer 191 so that the detector module 181 is also protected against damage in this transitional region 203.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A detector module for an X-ray detector, comprising in a stacked structure:
a sensor layer including a sensor surface to which a high voltage is appliable for the detection of X-rays, wherein a coherent protective film is arranged on at least two side surfaces of the stacked structure.

2. The detector module of claim 1, wherein the protective film covers the entire area of the side surfaces of the stacked structure.

3. The detector module of claim 1, wherein a conductive layer is applied to the sensor surface.

4. The detector module of claim 1, wherein a protective film is arranged on the sensor surface.

5. The detector module of claim 3, wherein a coherent protective film is arranged on the side surfaces and on the sensor surface.

6. The detector module of claim 1, wherein the protective film arranged on the side surfaces is provided with optical protection.

7. The detector module of claim 6, wherein the optical protection is applied as a coating on the protective film.

8. The detector module of claim 1, wherein the protective film is glued onto at least one of the side surfaces and the sensor surface.

9. The detector module of claim 6, wherein the optical protection is applied on the protective film in the form of an adhesive layer.

10. The detector module of claim 1, wherein the sensor layer in the stacked structure is applied on a readout unit.

11. The detector module of claim 10, wherein the readout unit in the stacked structure is applied on a carrier ceramic.

12. The detector module of claim 1, wherein a plastic film is used as the protective film.

13. The detector module of claim 1, wherein a shrink-on film is used as the protective film.

14. The detector module of claim 1, wherein the sensor layer comprises telluride.

15. An X-ray detector for recording an image of an object radiographed by X-rays comprising:
a number of the detector modules of claim 1, arranged adjacent to one another.

16. The X-ray detector of claim 15, wherein the carrier ceramic of each of the detector modules in the stacked structure is connected via a carrier to sensor electronics.

17. The detector module of claim 2, wherein a conductive layer is applied to the sensor surface.

18. The detector module of claim 17, wherein a coherent protective film is arranged on the side surfaces and on the sensor surface.

19. The detector module of claim 7, wherein the optical protection is applied on the protective film in the form of an adhesive layer.

20. The detector module of claim 8, wherein the optical protection is applied on the protective film in the form of an adhesive layer.

21. The detector module of claim 14, wherein the sensor layer comprises cadmium telluride (CdTe) or cadmium zinc telluride (CdZnTe).

22. An X-ray detector for recording an image of an object radiographed by X-rays comprising:
a number of the detector modules of claim 2, arranged adjacent to one another.

23. The X-ray detector of claim 22, wherein the carrier ceramic of each of the detector modules in the stacked structure is connected via a carrier to sensor electronics.
